(19) United States
(12) Patent Application Publication
(10) Pub. No.: US 2023/0138735 A1
(43) Pub. Date: May 4, 2023

(54) DISPLAY SYSTEM, PROGRAM, AND METHOD FOR CONTROLLING DISPLAY SYSTEM

(71) Applicant: KOMATSU LTD., Minato-ku, Tokyo (JP)

(72) Inventors: Mitsuhiko KAMADO, Minato-ku, Tokyo (JP); Akihiro KAGEYAMA, Minato-ku, Tokyo (JP); Hayato HISA, Minato-ku, Tokyo (JP); Toru OBARA, Kamakura-shi, Kanagawa (JP)

(73) Assignee: KOMATSU LTD., Minato-ku, Tokyo (JP)

(21) Appl. No.: 17/910,494

(22) PCT Filed: Mar. 17, 2021
(86) PCT No.: PCT/JP2021/010823

§ 371 Date: Sep. 9, 2022

(30) Foreign Application Priority Data
Apr. 3, 2020 (JP) 2020-067663

(51) Int. Cl. B60K 35/00

(52) U.S. Cl. CPC B60K 35/00; E02F 3/32

(57) ABSTRACT

A display system includes a display and a controller. The controller displays a third figure indicating a relative relationship between a first figure indicating an inclination of a bottom surface of a bucket and a second figure indicating an inclination of a target topography on the display.

### TECHNICAL FIELD

The present disclosure relates to a display system, a program, and a method for controlling the display system.

### BACKGROUND ART

In a hydraulic excavator, a working implement including a bucket is driven by an operator who operates an operation lever. At this time, it is difficult for the operator to perform excavation such that the operator obtains target construction topography while visually checking movement of the working implement and the current topography. Accordingly, technique for supporting the operation of the operator is required.

For example, WO 2015/030266 (PTL 1) discloses a display system of a working machine that provides information about a construction state to the operator. In this display system, a side view of the bucket is displayed on a display unit together with an image of the target construction topography.

### CITATION LIST

### Patent Literature

PTL 1: WO 2015/030266

### SUMMARY OF INVENTION

### Technical Problem

In order to support the operator who performs an excavation operation using the working machine, a positional relationship between a target topography and an excavation tool is desirably provided in a visually more understandable manner.

An object of the present disclosure is to provide a display system, a program, and a control method of the display system capable of providing the positional relationship between the target topography and the excavation tool in the visually more easily understandable manner.

### Solution to Problem

A display system according to one aspect of the present disclosure includes a display and a controller. The controller displays a third figure representing a relative relationship between a first figure indicating an inclination of a part of an excavation tool and a second figure indicating an inclination of a target topography on the display.

A display system according to another aspect of the present disclosure includes a display and a controller. The controller displays a first figure that is a straight line extended from a bottom surface of a bucket in side view of the bucket and a second figure that indicates an inclination of a target topography.

A program according to still another aspect of the present disclosure causes a processor of a controller to execute generating a first figure indicating an inclination of a part of an excavation tool, generating a second figure indicating an inclination of a target topography, generating a third figure representing a relative relationship between the first figure and the second figure, and displaying the third figure on a display.

A method for controlling a display system according to yet another aspect of the present disclosure, the method includes the following steps.

A first figure indicating an inclination of a part of an excavation tool is generated. A second figure indicating an inclination of a target topography is generated. A third figure representing a relative relationship between the first figure and the second figure is generated. The third figure is displayed on a display.

### Advantageous Effects of Invention

The display system, the program, and the control method for controlling the display system capable of providing a positional relationship between the target topography and the excavation tool in the visually more easily understandable manner can be implemented according to the present disclosure.

### BRIEF DESCRIPTION OF DRAWINGS

FIG. 1 is a perspective view illustrating a configuration of a hydraulic excavator as an example of a working machine according to an embodiment.

FIG. 2 is a side view of the hydraulic excavator.

FIG. 3 is a rear view of the hydraulic excavator.

FIG. 4 is a block diagram illustrating a control system included in a display system of the embodiment.

FIG. 5 is a view illustrating a target construction topography and a target topography.

FIG. 6 is a view illustrating an image in which a support image is displayed with a bucket as a center in a side view of the hydraulic excavator as a first example of a support screen displayed on a display unit.

FIG. 7 is a view illustrating the image at a viewpoint of the bucket and the target topography viewed from an operator who operates the hydraulic excavator as a second example of the support screen displayed on the display unit.

FIG. 8 is a view illustrating the image in which the support image is displayed with a vehicle body as the center in the side view of the hydraulic excavator as a third example of the support screen displayed on the display unit.

FIGS. 9(A) to 9(E) illustrate a method for generating the support image in order of steps.

FIGS. 10(A) to 10(E) are views illustrating the method for generating the support image in the side view of the hydraulic excavator in the order of steps subsequent to the steps in FIG. 9.

FIGS. 11(A) to 11(E) are views illustrating the method for generating the support image at the viewpoint form the bucket and the target topography from the operator who operates the hydraulic excavator in the order of steps subsequent to the steps in FIG. 9.

FIG. 12 is a flowchart illustrating a method for controlling the display system in the embodiment.

FIG. 13 is a view illustrating the image in which the support image indicating an extension line of a bucket bottom surface is displayed in the side view of the hydraulic excavator as a modification of the support screen displayed on the display unit.

FIG. 14 is a view illustrating a tilt bucket.

### DESCRIPTION OF EMBODIMENT

Hereinafter, an embodiment of the present disclosure will be described in detail with reference to the drawings. In the specification and the drawings, the same components or corresponding components are denoted by the same reference numerals, and redundant description will not be repeated. In the drawings, the configuration may be omitted or simplified for convenience of description. In addition, at least a part of the embodiment and each modification may be arbitrarily combined with each other.

<Overall Configuration of Working Machine>

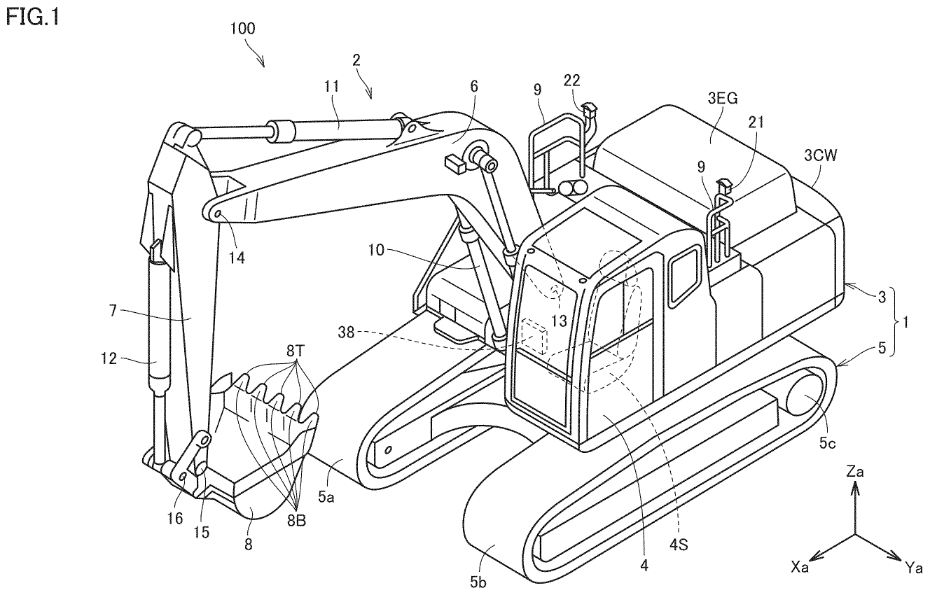

With reference to FIG. 1, a configuration of a hydraulic excavator as an example of a working machine to which the idea of the present disclosure can be applied will be described. The present disclosure is also applicable to a working machine having an excavation tool other than the following hydraulic excavator.

In the following description, a front-rear direction is a front-rear direction of the operator seated on a driver's seat 4S in an operator cab 4 in FIG. 1. A direction facing the operator seated on driver's seat 4S is a forward direction, and a direction behind the operator seated on driver's seat 4S is a backward direction. A left-right direction is a left-right direction of the operator seated on driver's seat 4S. A right side and a left side when the operator sits on driver's seat 4S faces a front are a right direction and a left direction, respectively. A vertical direction is a direction orthogonal to a plane defined by the front-back direction and the left-right direction. In the vertical direction, a side on which the ground exists is a lower side, and a side on which the sky exists is an upper side.

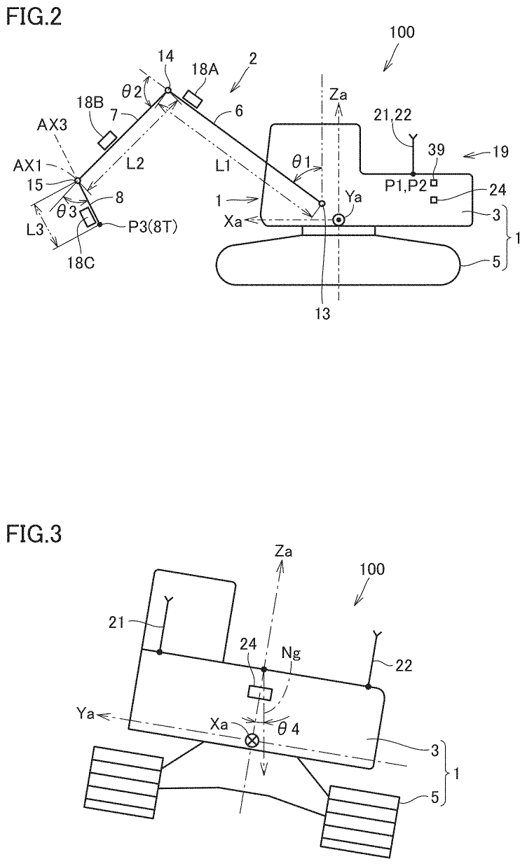

FIG. 1 is a perspective view illustrating the configuration of the hydraulic excavator as an example of the working machine according to an embodiment. FIGS. 2 and 3 are a side view and a rear view of the hydraulic excavator.

As illustrated in FIG. 1, a hydraulic excavator 100 as the working machine in the embodiment includes a machine body 1 and a working implement 2. Machine body 1 includes a revolving body 3 and a traveling device 5. Revolving body 3 accommodates devices such as a power generator and a hydraulic pump (not illustrated) in a machine chamber 3EG. Machine chamber 3EG is disposed on a rear end side of revolving body 3.

For example, hydraulic excavator 100 includes an internal combustion engine such as a diesel engine as a power generation device, but hydraulic excavator 100 is not limited to such the internal combustion engine. For example, hydraulic excavator 100 may include what is called a hybrid type power generation device in which the internal combustion engine, a generator motor, and a power storage device are combined.

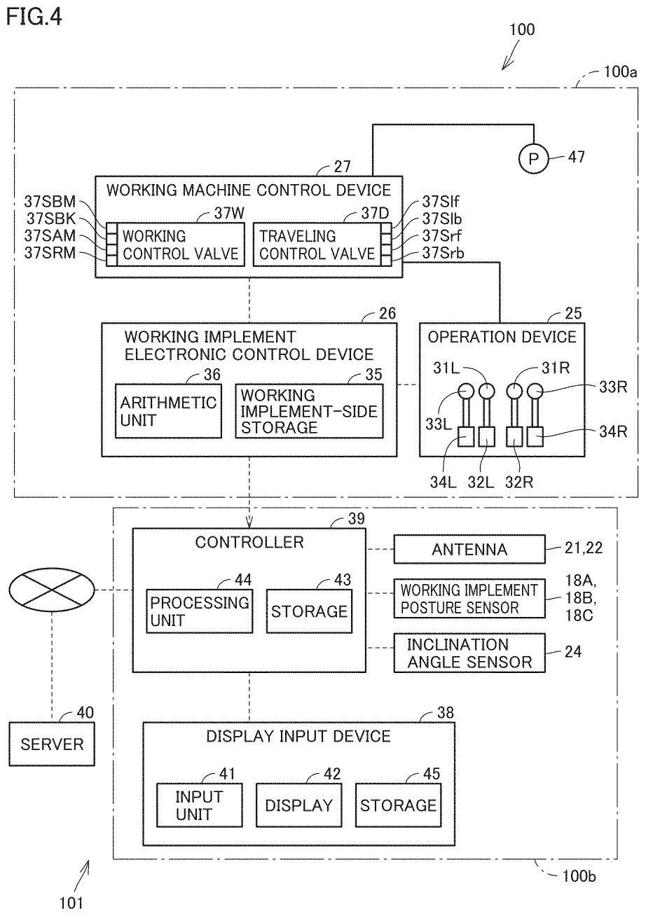

Revolving body 3 includes operator cab 4. Operator cab 4 is mounted on a front end side of revolving body 3. Operator cab 4 is disposed on a side opposite to a side where machine chamber 3EG is disposed. A display input device 38 and an operation device 25 are disposed in operator cab 4 (see FIG. 4). These will be described later.

Traveling device 5 is disposed below revolving body 3. Traveling device 5 includes crawler belts 5a, 5b. Traveling device 5 causes hydraulic excavator 100 to travel by a hydraulic motor 5c rotationally driving crawler belts 5a, 5b. Hydraulic excavator 100 may have tires instead of crawler belts 5a, 5b, or may be a wheel type hydraulic excavator.

A handrail 9 is provided on revolving body 3. Two GNSS antennas 21, 22 for real time kinematic-global navigation satellite systems (RTK-GNSS) are detachably attached to handrail 9.

For example, GNSS antennas 21, 22 are installed at a certain distance from each other along an axis parallel to a Ya-axis of a machine body coordinate system [Xa, Ya, Za]. GNSS antennas 21, 22 may be installed at a certain distance from each other along the axis parallel to an Xa-axis of machine body coordinate system [Xa, Ya, Za].

GNSS antennas 21, 22 are preferably installed at positions as far away from each other as possible from the viewpoint of improving detection accuracy of the current position of hydraulic excavator 100. In addition, GNSS antennas 21, 22 are preferably installed at positions that do not obstruct a field of view of the operator as much as possible. GNSS antennas 21, 22 may be installed on revolving body 3 and behind a counterweight 3CW or operator cab 4.

Working implement 2 is attached to a lateral side of operator cab 4 of revolving body 3. Working implement 2 includes a boom 6, an arm 7, a bucket 8, a boom cylinder 10, an arm cylinder 11, and a bucket cylinder 12. A base end of boom 6 is rotatably attached to the front of machine body 1 through a boom pin 13. A base end of arm 7 is rotatably attached to a tip of boom 6 through an arm pin 14. Bucket 8 is attached to the distal end of arm 7 through a bucket pin 15.

Bucket 8 includes a plurality of blades 8B. The plurality of blades 8B are attached to an end of bucket 8 on the side opposite to the side on which bucket pin 15 is attached. The plurality of blades 8B are attached to the end of bucket 8 farthest from the side to which bucket pin 15 is attached. The plurality of blades 8B are arrayed in a row in the direction parallel to bucket pin 15. Blade edge 8T is the tip of blade 8B. Blade edge 8T is the tip of bucket 8 at which working implement 2 generates excavation force. The direction parallel to a straight line connecting the plurality of blade edges 8T is a width direction of bucket 8. The width direction of bucket 8 is matched with the width direction of revolving body 3, namely, the left-right direction of revolving body 3.

Bucket 8 is coupled to bucket cylinder 12 through a pin 16. Bucket cylinder 12 expands and contracts to rotate bucket 8. Bucket 8 rotates about an axis orthogonal to the extending direction of arm 7. Boom pin 13, arm pin 14, and bucket pin 15 are disposed in a positional relationship parallel to each other. That is, the center axes of the pins are parallel to each other.

Each of boom cylinder 10, arm cylinder 11, and bucket cylinder 12 is a hydraulic cylinder. Each of boom cylinder 10, arm cylinder 11, and bucket cylinder 12 operates by adjusting the expansion and contraction and speed according to pressure or a flow rate of a hydraulic oil.

Boom cylinder 10 operates boom 6, and vertically rotates boom 6 about the center axis of boom pin 13. Arm cylinder 11 operates arm 7, and rotates arm 7 about the center axis of arm pin 14. Bucket cylinder 12 operates bucket 8, and rotates bucket 8 about the center axis of bucket pin 15.

The excavation tool of working machine 100 is not limited to bucket 8, but may be another excavation tool such as a breaker.

As illustrated in FIG. 2, a length of boom 6 (a length between boom pin 13 and arm pin 14) is L1. The length of arm 7 (the length from the center axis of arm pin 14 to a center axis AX1 of bucket pin 15) is L2. The length of bucket 8 (the length from center axis AX1 of bucket pin 15 to blade edge 8T) is L3. The length of bucket 8 is the length along an axis AX3 orthogonal to center axis AX1 of bucket pin 15 and passing through blade edge 8T of bucket 8.

An inertial measurement unit (IMU) 18A is disposed on boom 6. An IMU 18B is disposed in arm 7. An IMU 18C is disposed in bucket 8. Each of IMUs 18A, 18B, 18C is a working implement posture sensor that detects a posture of working implement 2. Each of IMUs 18A, 18B, 18C detects a triaxial angle (or angular velocity) and acceleration.

The postures of boom 6, arm 7, and bucket 8 can be detected from the triaxial angles (or angular velocities) and accelerations detected by IMUs 18A, 18B, 18C. Specifically, an inclination angle θ1 of boom 6 with respect to the Za-axis of the machine body coordinate system described later can be calculated from the triaxial angle (or angular velocity) and acceleration detected by IMU 18A. An inclination angle θ2 of arm 7 with respect to boom 6 can be calculated from the triaxial angle (or angular velocity) and acceleration detected by IMU 18B. An inclination angle θ3 of bucket 8 with respect to arm 7 can be calculated from the triaxial angle (or angular velocity) and acceleration detected by IMU 18C.

The working implement posture sensor is not limited to the IMU, but may be a stroke sensor, a potentiometer, an imaging device, or the like. The working implement posture sensors may be hydraulic sensors 37SBM, 37SBK, 37SAM in FIG. 4.

Machine body 1 includes a position detector 19. Position detector 19 detects the current position of hydraulic excavator 100. Position detector 19 includes GNSS antennas 21, 22, an inclination angle sensor 24, and a controller 39. Position detector 19 may include a three-dimensional position sensor.

Revolving body 3 and working implement 2 rotate with respect to traveling device 5 about a predetermined revolving center axis. Machine body coordinate system [Xa, Ya, Za] is a coordinate system of machine body 1. In the embodiment, in machine body coordinate system [Xa, Ya, Za], a revolving center axis of working implement 2 or the like is defined as the Za-axis, an axis orthogonal to the Za-axis and parallel to an operation plane of working implement 2 is defined as the Xa-axis, and an axis orthogonal to the Za-axis and the Xa-axis is defined as the Ya-axis. For example, the operation plane of working implement 2 is a plane orthogonal to boom pin 13. The Xa-axis corresponds to the front-rear direction of revolving body 3, and the Ya-axis corresponds to the width direction of revolving body 3.

A signal corresponding to a GNSS radio wave received by each of antennas 21, 22 is input to controller 39. GNSS antenna 21 receives reference position data P1 indicating an own installation position from a positioning satellite. GNSS antenna 22 receives reference position data P2 indicating the own installation position from the positioning satellite. For example, GNSS antennas 21, 22 receive reference position data P1, P2 at a cycle of 10 Hz. Reference position data P1, P2 are information about the position where the GNSS antenna is installed. Each time GNSS antennas 21, 22 receive reference position data P1, P2, GNSS antennas 21, 22 output reference position data P1, P2 to controller 39.

As illustrated in FIG. 3, inclination angle sensor 24 is attached to revolving body 3. Inclination angle sensor 24 detects an inclination angle θ4 of the width direction of machine body 1 with respect to the direction in which gravity acts, namely, vertical direction Ng. For example, inclination angle sensor 24 may be the IMU.

IMUs 18A, 18B, 18C, GNSS antennas 21, 22, inclination angle sensor 24, display input device 38, and controller 39 may be added to hydraulic excavator 100 as a retrofitted kit. Hereinafter, the hydraulic excavator equipped with the retrofitted kit is referred to as the hydraulic excavator 100, and the hydraulic excavator not equipped with the retrofitted kit is referred to as a hydraulic excavator 100a.

<Display System>

With reference to FIGS. 4 and 5, a display system of the embodiment will be described below. In the embodiment, the display system in the case where a retrofitted kit 100b is mounted on hydraulic excavator 100a later will be described as an example of the display system.

However, the display system of the present disclosure includes not only the case where retrofitted kit 100b is retrofitted to hydraulic excavator 100a after sale of hydraulic excavator 100a, but also the case where retrofitted kit 100b is mounted on hydraulic excavator 100a from the beginning of the sale of hydraulic excavator 100.

FIG. 4 is a block diagram illustrating a control system included in the display system of the embodiment. FIG. 5 is a view illustrating a target construction topography and a target topography. As illustrated in FIG. 4, a display system 101 of the embodiment is a system that provides information constructing the target construction topography in FIG. 5 for the operator during the excavation using hydraulic excavator 100, and supports the operation of the operator. Display system 101 includes hydraulic excavator 100a, retrofitted kit 100b, and a server 40.

Hydraulic excavator 100a includes operation device 25, a working implement electronic control device 26, a working machine control device 27, and a hydraulic pump 47.

Operation device 25 is a device that operates the operation of working implement 2 (FIG. 1) and the traveling of hydraulic excavator 100a. Operation device 25 includes working implement operation members 31L, 31R, traveling operation members 33L, 33R, working implement operation detectors 32L, 32R, and traveling operation detectors 34L, 34R. For example, working implement operation members 31L, 31R and traveling operation members 33L, 33R are pilot-pressure type levers, but are not limited thereto. For example, working implement operation members 31L, 31R and traveling operation members 33L, 33R may be electric type levers.

Working implement operation detectors 32L, 32R function as operation detectors that detect inputs to working implement operation members 31L, 31R as operation units. Traveling operation detectors 34L, 34R function as operation detectors that detect inputs to traveling operation members 33L, 33R as operation units.

Working machine control device 27 is a hydraulic device including a hydraulic control valve and the like. Working machine control device 27 drives and controls boom cylinder 10, arm cylinder 11, bucket cylinder 12, a revolving motor, and hydraulic motor 5c based on the operation in operation device 25.

Working machine control device 27 includes a traveling control valve 37D and a working control valve 37W. For example, each of traveling control valve 37D and working control valve 37W is a proportional control valve. Traveling control valve 37D is controlled by the pilot pressure from traveling operation detectors 34L, 34R. Working control valve 37W is controlled by the pilot pressure from working implement operation detectors 32L, 32R.

Working machine control device 27 includes hydraulic sensors 37S1f, 37S1b, 37Srf, 37Srb. Each of hydraulic sensors 37S1f, 37S1b, 37Srf, 37Srb detects magnitude of the pilot pressure supplied to traveling control valve 37D and generates a corresponding electric signal. Hydraulic sensors 37S1f, 37S1b, 37Srf, and 37Srb function as operation detectors that detect inputs to traveling operation members 33L, 33R as operation units.

Hydraulic sensor 37S1f detects the pilot pressure for leftward forward movement. Hydraulic sensor 37S1b detects the pilot pressure for leftward backward movement. Hydraulic sensor 37Srf detects the pilot pressure for rightward forward movement. Hydraulic sensor 37Srb detects the pilot pressure for rightward backward movement.

When the operator operates traveling operation members 33L, 33R, the hydraulic oil having a flow rate corresponding to the pilot pressure generated in response to the operation flows out from traveling control valve 37D. The hydraulic oil flowing out of traveling control valve 37D is supplied to hydraulic motor 5c of traveling device 5. Thus, crawler belts 5a, 5b are rotationally driven.

Working machine control device 27 includes hydraulic sensors 37SBM, 37SBK, 37SAM, 37SRM. Each of hydraulic sensors 37SBM, 37SBK, 37SAM, 37SRM detects the magnitude of the pilot pressure supplied to working control valve 37W and generates a corresponding electric signal. Hydraulic sensors 37SBM, 37SBK, 37SAM, 37SRM function as operation detectors that detect inputs to working implement operation members 31L, 31R as operation units.

Hydraulic sensor 37SBM detects the pilot pressure corresponding to boom cylinder 10. Hydraulic sensor 37SAM detects the pilot pressure corresponding to arm cylinder 11. Hydraulic sensor 37SBK detects a pilot pressure corresponding to bucket cylinder 12. Hydraulic sensor 37SRM detects the pilot pressure corresponding to the revolving motor.

When the operator operates working implement operation members 31L, 31R, the hydraulic oil having a flow rate corresponding to the pilot pressure generated in response to the operation flows out of working control valve 37W. The hydraulic oil flowing out of working control valve 37W is supplied to at least one of boom cylinder 10, arm cylinder 11, bucket cylinder 12, and revolving motor. Thus, cylinders 10, 11, 12 expand and contract, and the revolving motor is revolved.

Working implement electronic control device 26 acquires the electric signal indicating the magnitude of the pilot pressure generated by working machine control device 27. Working implement electronic control device 26 controls the engine and the hydraulic pump based on the acquired electric signal. In addition, working implement electronic control device 26 outputs the acquired electric signal to controller 39 in order to generate the support screen described later. For example, when the hydraulic sensors 37SBM, 37SBK, 37SAM are used as the working implement posture sensors, working implement electronic control device 26 outputs the acquired electric signals of hydraulic sensors 37SBM, 37SBK, 37SAM to controller 39. In this manner, the posture of working implement 2 may be detected based on an operation instruction signal.

Controller 39 and working implement electronic control device 26 can communicate with each other by wireless or wired communication means.

Working implement operation members 31L, 31R and traveling operation members 33L, 33R may be electric type levers. In this case, working implement electronic control device 26 generates a control signal in order to operate working implement 2, revolving body 3, or traveling device 5 according to the operation of working implement operation members 31L, 31R or traveling operation members 33L, 33R. Working implement electronic control device 26 outputs the generated control signal to working machine control device 27 and controller 39.

Working control valve 37W and traveling control valve 37D of working machine control device 27 are controlled based on the control signal from working implement electronic control device 26. The hydraulic oil having the flow rate according to the control signal from working implement electronic control device 26 flows out of working control valve 37W, and is supplied to at least one of boom cylinder 10, arm cylinder 11, and bucket cylinder 12. Consequently, working implement 2 operates. In addition, the hydraulic oil having the flow rate according to the control signal from working implement electronic control device 26 flows out from traveling control valve 37D and is supplied to hydraulic motor 5c. Consequently, traveling device 5 operates.

Working implement electronic control device 26 includes a working implement-side storage 35 including at least one of a random access memory (RAM) and a read only memory (ROM) and an arithmetic unit 36 such as a central processing unit (CPU). Working implement electronic control device 26 mainly controls the operations of working implement 2 and revolving body 3. Working implement-side storage 35 stores information such as a computer program controlling working implement 2.

Although working implement electronic control device 26 and controller 39 are separated from each other, the present invention is not limited to such the form. Working implement electronic control device 26 and controller 39 may be integrated without being separated.

Retrofitted kit 100b is mounted on hydraulic excavator 100 in order to implement display system 101. Retrofitted kit 100b includes working implement posture sensors 18A, 18B, 18C, GNSS antennas 21, 22, inclination angle sensor 24, display input device 38, and controller 39.

Controller 39 performs various functions of display system 101. Controller 39 includes a storage 43 and a processing unit 44. Storage 43 includes at least one of the RAM and the ROM. Processing unit 44 includes the CPU and the like.

Storage 43 stores working implement data. Working implement data includes a length L1 of boom 6, a length L2 of arm 7, a length L3 of bucket 8, and the like. When bucket 8 is replaced, a value corresponding to the size of replaced bucket 8 is input from input unit 41 and stored in storage 43 as length L3 of bucket 8 for working implement data.

The working implement data includes the minimum value and the maximum value of each of inclination angle θ1 of boom 6, inclination angle θ2 of arm 7, and inclination angle θ3 of bucket 8. Storage 43 stores an image display computer program (hereinafter, referred to as an “image display program”), information about the coordinates of the machine body coordinate system, and the like.

The image display program may not be stored in storage 43 but may be stored in server 40. For example, server 40 is connected to controller 39 through the Internet line. In this case, in response to a request from the operator who operates hydraulic excavator 100, controller 39 accesses server 40 to execute the image display program stored in server 40. Then, the image as a result of the execution is displayed on a display 42 through the Internet line.

GNSS correction information may be transmitted from server 40 to controller 39 through the Internet line. Furthermore, a construction history by hydraulic excavator 100 may be transmitted from controller 39 to server 40 through the Internet line.

Storage 43 stores previously-prepared target construction topography data. The target construction topography data is information about the shape and position of the three-dimensional target construction topography.

As illustrated in FIG. 5, the target construction topography indicates a target shape of the ground that becomes a working target. The target construction topography is constructed with a plurality of design surfaces 71 each of which is represented by a triangular polygon.

The working target is at least one of design surfaces 71. The operator selects at least one of design surfaces 71 as a target topography 70. Target topography 70 is a surface to be excavated from among the plurality of design surfaces 71. Target topography 70 indicates the target shape of a working target.

As illustrated in FIG. 4, processing unit 44 reads and executes the image display program stored in storage 43 or server 40. Thus, processing unit 44 causes display 42 to display the support screen. The support screen includes information about the positional relationship between bucket 8 being excavated and target topography 70. In addition, the support screen includes posture information about bucket 8 in order to support the operation of bucket 8 that is operated by the operator of hydraulic excavator 100.

Controller 39 acquires two reference position data P1, P2 (a plurality of pieces of reference position data) represented in the global coordinate system from GNSS antennas 21, 22. Controller 39 generates revolving body disposition data indicating the disposition of revolving body 3 based on two reference position data P1, P2.

Revolving body disposition data includes one reference position data P of two reference position data P1, P2 and revolving body orientation data Q generated based on two reference position data P1, P2. In revolving body orientation data Q, an orientation determined from reference position data P acquired by GNSS antennas 21, 22 is determined based on an angle relative to a reference orientation (for example, north) of a global coordinate.

Revolving body orientation data Q indicates the direction on which revolving body 3 faces (the orientation to which working implement 2 faces). Controller 39 updates the revolving body disposition data, namely, reference position data P and revolving body orientation data Q each time two reference position data P1, P2 are acquired from GNSS antennas 21, 22 at a frequency of, for example, 10 Hz.

Controller 39 acquires detection information about boom 6, arm 7, and bucket 8 from IMUS 18A, 18B, 18C. Controller 39 calculates the attitude of working implement 2 based on the detection information about IMUS 18A, 18B, 18C. Specifically, controller 39 calculates inclination angle θ1 of boom 6 based on the detection information about IMU 18A, calculates inclination angle θ2 of arm 7 based on the detection information about IMU 18B, and calculates inclination angle θ3 of bucket 8 based on the detection information about IMU 18C.

When hydraulic sensors 37SBM, 37SBK, 37SAM are used as the working implement posture sensors, working implement posture sensors 18A, 18B, 18C may be omitted from retrofitted kit 100b. When hydraulic sensors 37SBM, 37SBK, 37SAM are used as the working implement posture sensors, processing unit 44 of controller 39 calculates inclination angles θ1, θ2, θ3 based on the electric signals indicating the magnitudes of the pilot pressures detected by hydraulic sensors 37SBM, 37SBK, 37SAM.

Controller 39 acquires inclination information about machine body 1 from inclination angle sensor 24. As illustrated in FIG. 3, the inclination information is an inclination angle θ4 of the width direction of machine body 1 with respect to vertical direction Ng.

As described above, processing unit 44 of controller 39 can calculate the relative position of hydraulic excavator 100 with respect to the target topography and the posture of working implement 2. Thus, processing unit 44 can display information about the positional relationship between bucket 8 being excavated and the target topography, posture information guiding the operator to the operation of bucket 8, and the like on display 42.

Display input device 38 includes input unit 41, display 42, and storage 45. For example, input unit 41 is a button, a keyboard, a touch panel, or a combination thereof.

For example, display 42 is a liquid crystal display (LCD) or an organic electro luminescence (EL) display. For example, storage 45 stores an application (software) reading and executing the image display program.

Display input device 38 is connected to controller 39 in a wireless or wired manner. Display input device 38 and controller 39 are wirelessly connected by, for example, Wi-Fi (registered trademark), BLUETOOTH (registered trademark), or Wi-SUN (registered trademark).

Display input device 38 may not be included in the above-described retrofitted kit. In this case, the user may substitute an own information portable terminal (smartphone, tablet, personal computer, and the like) as display input device 38. In addition, a display device existing in hydraulic excavator 100 may be substituted as display input device 38.

Display input device 38 displays the support screen providing information to the operator in order to perform the excavation using working implement 2. Also, various keys are displayed on the support screen. The operator can perform various functions of display system 101 by touching various keys on the support screen. The support screen will be described later.

<Support Screen>

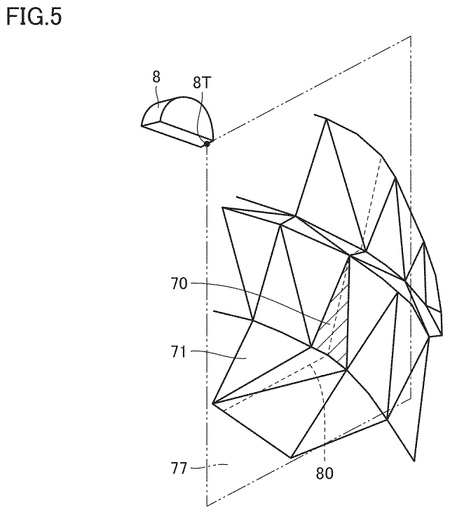

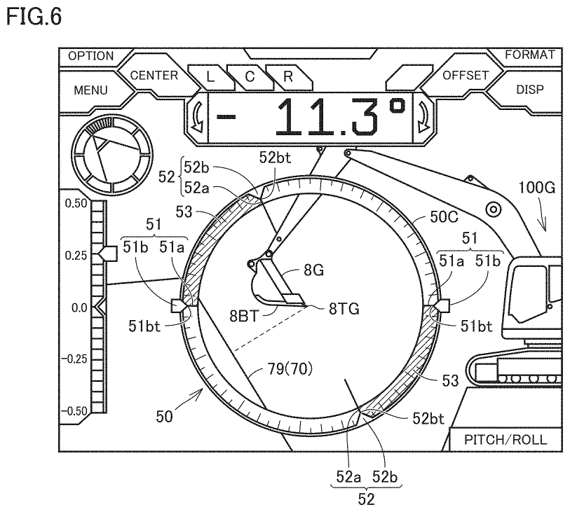

With reference to FIGS. 6 to 8, first to third examples of the support screen displayed on display 42 in the display system of the embodiment will be described below.

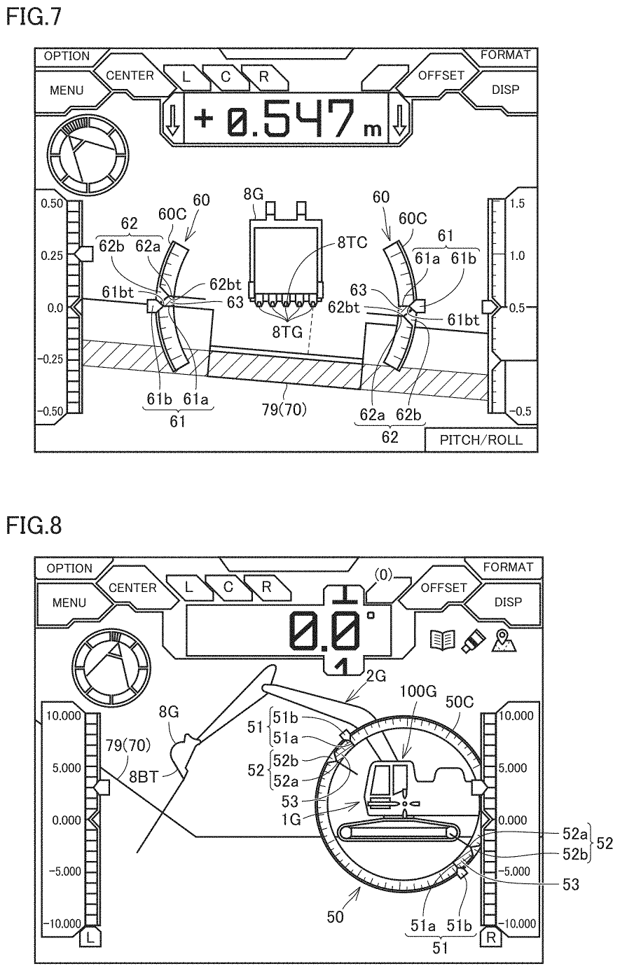

FIG. 6 is a view illustrating an image in which a support image is displayed with the bucket as a center in the side view of the hydraulic excavator as the first example of the support screen displayed on the display unit. FIG. 7 is a view illustrating the image at a viewpoint of the bucket and the target topography viewed from the operator who operates the hydraulic excavator as the second example of the support screen displayed on the display unit. FIG. 8 is a view illustrating the image in which the support image is displayed with a vehicle body as the center in the side view of the hydraulic excavator as the third example of the support screen displayed on the display unit.

As illustrated in FIG. 6, the first example of the support screen includes a working machine image 100G, an image 79 of the target construction topography, and a support image 50. Working machine image 100G is an image of the working machine viewed from the side face (an image viewed from the side face of the working machine). Working machine image 100G includes an image 8G of the bucket (excavation tool). Image 79 of the target construction topography includes target topography 70.

Support image 50 includes a first FIG. 51, a second FIG. 52, and a third FIG. 53. First FIG. 51 indicates the inclination of a part of bucket 8. For example, first FIG. 51 is a figure indicating the inclination of a bottom surface 8BT of the bucket. First FIG. 51 is located on a virtual straight line along bottom surface 8BT of the bucket in side view.

For example, first FIG. 51 is both or one of a straight line 51a and a FIG. 51b having a home base shape (pentagonal shape). Straight line 51a is a straight line that passes through bottom surface 8BT of the bucket and is superimposed on a virtual straight line along bottom surface 8BT of the bucket. A corner 51bt in FIG. 51b having the home base shape is located on a virtual straight line passing through bottom surface 8BT of the bucket and along bottom surface 8BT of the bucket. FIG. 51b may have a polygonal shape such as a triangle or a circular shape such as a circle or an ellipse as long as the inclination of bottom surface 8BT of the bucket can be specified.

Second FIG. 52 indicates the inclination of target topography 70. For example, second FIG. 52 is both or one of a straight line 52a and a triangular FIG. 52b. Straight line 52a is a straight line superimposed on a virtual straight line parallel to target topography 70. A corner 52bt in triangular FIG. 52b is located on a virtual straight line parallel to target topography 70. FIG. 52b may have a polygonal shape other than the triangle or the circular shape such as the circle or the ellipse as long as the inclination of target topography 70 can be specified.

Third FIG. 53 is a hatched region in the drawing. Third FIG. 53 is a figure representing a relative relationship between first FIG. 51 and second FIG. 52. For example, third FIG. 53 is a figure connecting first FIG. 51 and second FIG. 52. Third FIG. 53 continuously connects first FIG. 51 and second FIG. 52 without interruption. For example, third FIG. 53 extends in a band shape and connects first FIG. 51 and second FIG. 52.

A virtual straight line (first straight line) along the inclination indicated by first FIG. 51 and a virtual straight line (second straight line) along the inclination indicated by second FIG. 52 pass through the same fixed point coordinate on display 42. For example, both the virtual straight line along the inclination indicated by first FIG. 51 and the virtual straight line along the inclination indicated by second FIG. 52 pass through blade edge 8TG of bucket image 8G (meaning the image of blade edge 8T on the screen) in side view.

For example, support image 50 includes an annular image 50C centered on a predetermined portion in the support screen. Annular image 50C included in support image 50 is along the circumference centered on, for example, blade edge 8TG (predetermined portion) of bucket image 8G in side view as the predetermined portion.

Annular image 50C is an image in which a long belt is bent and rounded. Straight line 51a of first FIG. 51 and straight line 52a of second FIG. 52 are illustrated in the belt of annular image 50C. Each of straight line 51a and straight line 52a extends in the radial direction of the annular ring included in support image 50. Corner 51bt of FIG. 51b having the home base shape and corner 52bt of triangular FIG. 52b are positioned in the belt of annular image 50C. Third FIG. 53 is illustrated in the belt of annular image 50C. Third FIG. 53 has a belt-like arc shape connecting first FIG. 51 and second FIG. 52.

Two first FIGS. 51 and two second FIGS. 52 are illustrated In the belt of annular image 50C. Two first FIGS. 51 face each other across the center (blade edge 8TG) of annular image 50C. Two second FIGS. 52 face each other across the center (blade edge 8TG) of annular image 50C.

The annular ring included in support image 50 is illustrated so as to surround the periphery of bucket image 8G. In this case, the circle on the inner peripheral side constituting the belt-like annular ring is illustrated on the outer peripheral side of bucket image 8G so as not to overlap bucket image 8G.

A scale may be illustrated in the belt of annular image 50C included in support image 50. The scale extends in the radial direction in the belt of annular image 50C. The arc-shaped portion in third FIG. 53 is colored differently from other portions in the belt of annular image 50C. For example, the color of the arc shape in third FIG. 53 is red, and the color of other portions in the belt of the circular ring is a color other than red, for example, black.

When the actual posture of bucket 8 changes due to the excavation, the posture of bucket image 8G in support image 50 also changes according to the actual posture of bucket 8. When the inclination of bottom surface 8BT of the bucket changes due to the posture change of bucket image 8G, the position of first FIG. 51 changes according to the change in the inclination. Specifically, first FIG. 51 moves in the circumferential direction in the belt of annular image 50C.

The operator can check the inclination of bucket 8 with respect to target topography 70 in real time by visually recognizing support image 50. Thus, the inclination angle of bucket 8 can be appropriately operated at the time of excavating target topography 70.

As illustrated in FIG. 7, the second example of the support screen includes bucket image 8G, image 79 of the target construction topography, and a support image 60. Bucket image 8G and image 79 of the target construction topography are images at a viewpoint (operator's view) from which the operator seated on the driver's seat 4S (FIG. 1) looks at bucket 8. Image 79 of the target construction topography includes target topography 70.

Support image 60 includes a first FIG. 61, a second FIG. 62, and a third FIG. 63. First FIG. 61 indicates the inclination of a part of bucket 8. For example, first FIG. 61 is a figure indicating the inclination in the direction in which blade edges 8TG of the bucket are arranged. First FIG. 61 is located on the virtual straight line along the direction in which blade edges 8TG of the bucket are arranged in operator view.

For example, first FIG. 61 is both or one of a straight line 61a and a FIG. 61b having the home base shape (pentagonal shape). Straight line 61a is a straight line superimposed on a virtual straight line passing through the plurality of blade edges 8TG. A corner 61bt of FIG. 61b having the home base shape is positioned on the virtual straight line passing through the plurality of blade edges 8TG. FIG. 61b may have a polygonal shape such as a triangle or a circular shape such as a circle or an ellipse as long as the inclination of the plurality of blade edges 8TG of the bucket can be specified.

Second FIG. 62 indicates the inclination of target topography 70. For example, second FIG. 62 is both or one of a straight line 62a and a triangular FIG. 62b. Straight line 62a is a straight line superimposed on a virtual straight line parallel to target topography 70. A corner 62bt of triangular FIG. 62b is located on a virtual straight line parallel to target topography 70. FIG. 62b may have a polygonal shape other than the triangle or the circular shape such as the circle or the ellipse as long as the inclination of target topography 70 can be specified.

Third FIG. 63 is a hatched region in the drawing. Third FIG. 63 is a figure connecting first FIG. 61 and second FIG. 62. Third FIG. 63 continuously connects first FIG. 61 and second FIG. 62 without interruption. For example, third FIG. 63 extends in a belt shape and connects first FIG. 61 and second FIG. 62.

A virtual straight line (first straight line) along the inclination indicated by first FIG. 61 and a virtual straight line (second straight line) along the inclination indicated by second FIG. 62 pass through the same fixed point coordinate on display 42. For example, both the virtual straight line along the inclination indicated by first FIG. 61 and the virtual straight line along the inclination indicated by second FIG. 62 pass through a center 8TC in the width direction of the plurality of blade edges 8TG as viewed from the operator.

For example, support image 60 includes a belt-shaped arc image 60C centered on a predetermined portion in the support screen. Belt-shaped arc image 60C included in support image 60 is along the circumference centered on center 8TC (predetermined portion) in the width direction of the plurality of blade edges 8TG as viewed from, for example, the operator as the predetermined portion.

Straight line 61a of first FIG. 61 and straight line 62a of second FIG. 62 are illustrated in the belt of arc image 60C. Each of straight line 61a and straight line 62a extends in the radial direction of arc image 60C. Corner 61bt of FIG. 61b having the home base shape and corner 62bt of triangular FIG. 62b are positioned in the belt of arc image 60C. Third FIG. 63 is illustrated in the belt of arc image 60C. Third FIG. 63 has a belt-like arc shape connecting first FIG. 61 and second FIG. 62.

Two arc images 60C are illustrated. Each of two arc images 60C is an arc centered on center 8TC in the width direction of the plurality of blade edges 8TG. One first FIG. 61 and one second FIG. 62 are illustrated in the belt of one arc image 60C. Two first FIGS. 61 face each other across center 8TC in the width direction of the plurality of blade edges 8TG. Two second FIGS. 62 face each other across center 8TC in the width direction of the plurality of blade edges 8TG.

Two arc images 60C are illustrated so as to surround the periphery of bucket image 8G. In this case, the arc on the inner peripheral side constituting each of two arc images 60C is illustrated on the outer peripheral side of bucket image 8G so as not to overlap bucket image 8G.

A scale may be illustrated in each belt of two arc images 60C. The scale extends in the radial direction in the belt of arc image 60C. The portion of the arc shape in third FIG. 63 is colored differently from other portions in the belt of arc image 60C. For example, the color of the arc shape in third FIG. 63 is red, and the color of other portions in the belt of arc image 60C is a color other than red, for example, black.

When the actual posture of bucket 8 changes due to the excavation, the posture of bucket image 8G in support image 60 also changes according to the actual posture of bucket 8. When the inclination in the direction in which the plurality of blade edges 8TG are arranged changes due to the posture change of bucket image 8G, the position of first FIG. 61 changes according to the change in the inclination. Specifically, first FIG. 61 moves in the circumferential direction within the belt of arc image 60C.

The operator can check the inclination of bucket 8 with respect to target topography 70 in real time by visually recognizing support image 60. Thus, the inclination angle of bucket 8 can be appropriately operated at the time of excavating target topography 70.

As illustrated in FIG. 8, the third example of the support screen includes working machine image 100G, image 79 of the target construction topography, and support image 50. Working machine image 100G is an image of the working machine viewed from the side face (an image viewed from the side face of the working machine). Working machine image 100G includes image 1G of the machine body and image 2G of the working implement. Image 79 of the target construction topography includes target topography 70.

Support image 50 is the same image as support image 50 in FIG. 6. A virtual straight line (first straight line) along the inclination indicated by first FIG. 51 and a virtual straight line (second straight line) along the inclination indicated by second FIG. 52 pass through the same fixed point coordinate on display 42. For example, both the virtual straight line along the inclination indicated by first FIG. 51 and the virtual straight line along the inclination indicated by second FIG. 52 pass through a predetermined portion of the working machine in side view.

For example, support image 50 includes annular image 50C centered on a predetermined portion in the support screen. Annular image 50C included in support image 50 is along the circumference centered on the center (predetermined portion) of machine body image 1G, for example, in side view as the predetermined portion.

Annular image 50C included in support image 50 is illustrated so as to surround the periphery of machine body image 1G. In this case, the circle on the inner peripheral side constituting annular image 50C is illustrated on the outer peripheral side of machine body image 1G so as not to overlap machine body image 1G.

When the actual posture of bucket 8 changes due to the excavation, the posture of bucket image 8G in support image 50 also changes according to the actual posture of bucket 8. When the inclination of bottom surface 8BT of the bucket changes due to the posture change of bucket image 8G, the position of first FIG. 51 changes according to the change in the inclination. Specifically, first FIG. 51 moves in the circumferential direction in the belt of annular image 50C.

The operator can check the inclination of bucket 8 with respect to target topography 70 in real time by visually recognizing support image 50. Thus, the inclination angle of bucket 8 can be appropriately operated at the time of excavating target topography 70.

The operator can switch the support screen display in FIGS. 6, 7, and 8 by the switching operation of the support screen.

In the above description, annular image 50C is not limited to the annular shape, but may be a polygonal shape such as a triangle or a circular shape such as a circle or an ellipse.

<Method for Generating Support Image>

With reference to FIGS. 4 and 9 to 11, a method for generating the first example and the second example of the support screen of the embodiment will be described below.

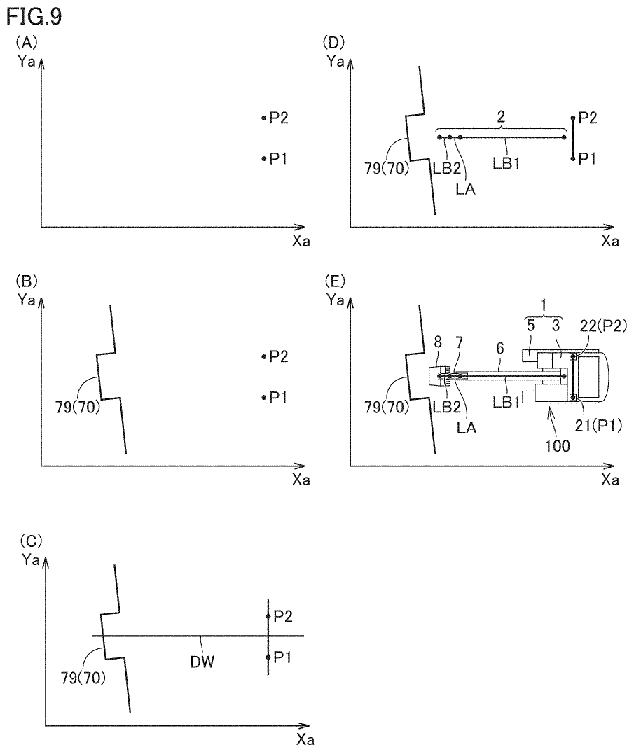

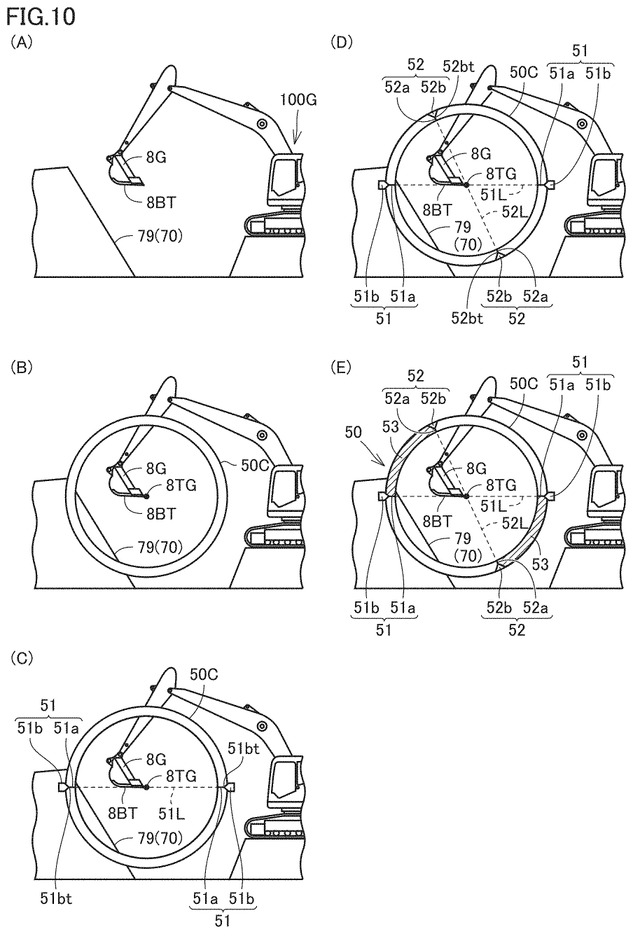

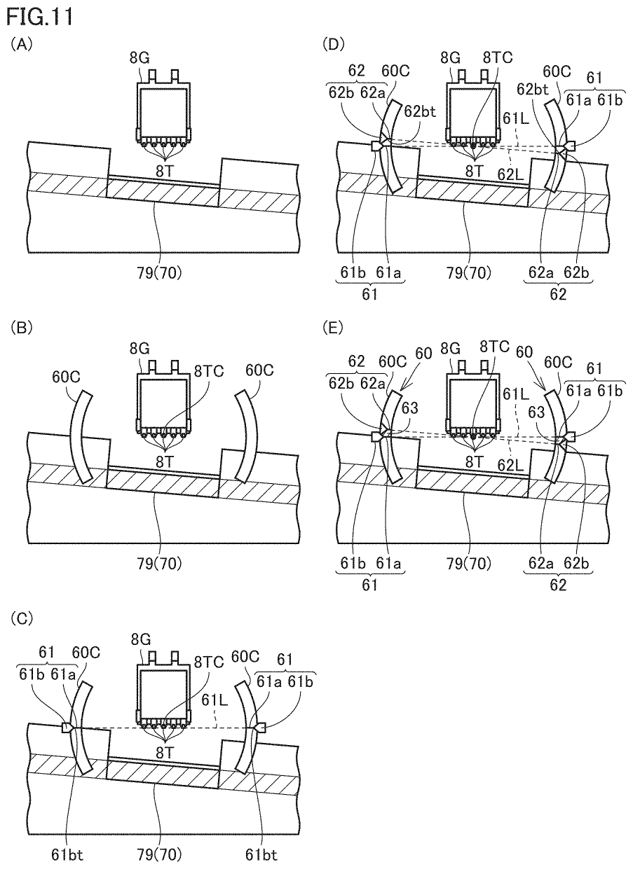

FIGS. 9(A) to 9(E) illustrate the method for generating the support image in order of steps. FIGS. 10(A) to 10(E) illustrate the method for generating the support image in side view of the hydraulic excavator in the order of steps subsequent to the steps of FIG. 9. FIGS. 11(A) to 11(E) are diagrams illustrating the method for generating the support image at the viewpoint of viewing the bucket and the target topography from the operator who operates the hydraulic excavator in the order of steps subsequent to the steps of FIG. 9.

FIGS. 9(A) to 9(E) illustrate viewpoints when the Xa-Ya plane is viewed from the Za-axis direction, where the horizontal axis is the Xa-axis and the vertical axis is the Ya-axis.

As illustrated in FIG. 4, processing unit 44 of controller 39 reads and executes the image display program stored in storage 43 or server 40, generates the support screen, and displays the support screen on display 42. The reason is as follows.

As illustrated in FIG. 9(A), processing unit 44 of controller 39 acquires two reference position data P1, P2 (a plurality of reference position data) represented in the global coordinate system from GNSS antennas 21, 22. Processing unit 44 of controller 39 determines the position in the coordinate system based on one reference position data P of two reference position data P1, P2. Thereafter, processing unit 44 of controller 39 determines which direction the line connecting the coordinates of two reference position data P1, P2 is directed with respect to the reference orientation (for example, north) of the global coordinate.

As illustrated in FIG. 9(B), processing unit 44 of controller 39 positions the target construction topography with respect to reference position data P1, P2 in the coordinate system based on the reference position data and the determined orientation. At this time, processing unit 44 of controller 39 acquires the previously-produced target construction topography data from storage 43 or server 40, and collates the shape and coordinates of the three-dimensional target construction topography included in the target construction topography data with the coordinates of reference position data P1, P2.

As illustrated in FIG. 9(C), processing unit 44 of controller 39 determines a direction DW of the operation plane of working implement 2 based on two reference position data P1, P2.

As illustrated in FIG. 9(D), processing unit 44 of controller 39 determines the posture of working implement 2. At this point, processing unit 44 of controller 39 acquires the postures of boom 6, 18A arm 7, and bucket 8 from working implement posture sensors 18A, 18B, 18C. Alternatively, processing unit 44 of controller 39 acquires electric signals of hydraulic sensors 37SBM, 37SBK, 37SAM through working implement electronic control device 26. Processing unit 44 of controller 39 calculates the posture (θ1, θ2, θ3) of working implement 2 based on the acquired information, and determines a position LB1 of boom 6, a position LB2 of arm 7, and a position LA of bucket 8.

As illustrated in FIG. 9(E), processing unit 44 of controller 39 disposes a 3D (dimension) model of hydraulic excavator 100 based on reference position data P1, P2 determined above, direction DW of the operation plane of working implement 2, the posture (01, 02, 03) of working implement 2, and the like. At this point, processing unit 44 of controller 39 acquires the 3D model of hydraulic excavator 100 stored in storage 43 or server 40.

As illustrated in FIG. 10(A), processing unit 44 of controller 39 produces working machine image 100G in side view based on the 3D model obtained in FIG. 9(E). In addition, processing unit 44 of controller 39 produces image 79 of the target construction topography in side view. As illustrated in FIG. 5, image 79 of the target construction topography is obtained by calculating an intersection line 80 between a plane 77 passing through the current position of blade edge 8T of bucket 8 and design surface 71.

As illustrated in FIG. 10(B), processing unit 44 of controller 39 generates annular image 50C centered on a predetermined position (for example, blade edge 8TG) in bucket image 8G in side view. Annular image 50C is generated so as to surround the periphery of bucket image 8G.

As illustrated in FIG. 10(C), processing unit 44 of controller 39 generates first FIG. 51 indicating the inclination of a part (for example, bottom surface 8BT) of bucket image 8G in the side view. First FIG. 51 is located on a virtual straight line 51L (first straight line) passing through bottom surface 8BT of the bucket and along bottom surface 8BT of the bucket in side view.

For example, first FIG. 51 is both or one of a straight line 51a and a FIG. 51b having a home base shape (pentagonal shape). Straight line 51a is a straight line superimposed on straight line 51L. Corner 51bt of FIG. 51b having the home base shape is located on straight line 51L.

As illustrated in FIG. 10(D), processing unit 44 of controller 39 generates second FIG. 52 indicating the inclination of target topography 70 in side view. Second FIG. 52 is located on a virtual straight line 52L (second straight line) parallel to target topography 70 in side view.

For example, second FIG. 52 is both or one of a straight line 52a and a triangular FIG. 52b. Straight line 52a is a straight line superimposed on straight line 52L. Corner 52bt of triangular FIG. 52b is located on straight line 52L.

Straight line 51L and straight line 52L are set so as to pass through the same point coordinate fixed on display 42. For example, straight line 51L and straight line 52L are set so as to pass through the same point (blade edge 8TG) in side view.

As illustrated in FIG. 10(E), processing unit 44 of controller 39 generates third FIG. 53 connecting first FIG. 51 and second FIG. 52 in side view. Third FIG. 53 continuously connects first FIG. 51 and second FIG. 52 without interruption. For example, third FIG. 53 extends in a band shape and connects first FIG. 51 and second FIG. 52.

For example, third FIG. 53 is generated as the arc portion in the belt in annular image 50C. For example, third FIG. 53 is generated in a color different from other arc portions in the belt in annular image 50C.

When the actual posture of bucket 8 changes due to the excavation, the posture of bucket image 8G in the support image also changes according to the actual posture of bucket 8. When the inclination of bottom surface 8BT of the bucket changes due to the posture change of bucket image 8G, the position of first FIG. 51 changes according to the change in the inclination. Specifically, first FIG. 51 moves in the circumferential direction in the annular belt. Thus, the circumferential length of third FIG. 53 having the arc shape changes.

As illustrated in FIG. 11(A), processing unit 44 of controller 39 produces bucket image 8G in operator's view based on the 3D model obtained in FIG. 9(E). In addition, processing unit 44 of controller 39 produces image 79 of the target construction topography in operator's view.

As illustrated in FIG. 11(B), processing unit 44 of controller 39 generates image 60C of an arc centered on a predetermined position (for example, center 8TC in the width direction of the plurality of blade edges 8TG) in bucket image 8G in operator's view. Arc image 60C is generated so as to surround the periphery of bucket image 8G. Specifically, two arc images 60C are generated so as to sandwich bucket image 8G from the left and right directions.

As illustrated in FIG. 11(C), processing unit 44 of controller 39 generates first FIG. 61 indicating the inclination of a part of bucket image 8G (for example, the direction in which the plurality of blade edges 8TG are arranged) in operator's view. First FIG. 61 is positioned on a virtual straight line 61L (first straight line) passing through the plurality of blade edges 8TG in operator's view.

For example, first FIG. 61 is both or one of a straight line 61a and a FIG. 61b having the home base shape (pentagonal shape). Straight line 61a is a straight line superimposed on straight line 61L. Corner 61bt of FIG. 61b having the home base shape is located on straight line 51L.

As illustrated in FIG. 11(D), processing unit 44 of controller 39 generates second FIG. 62 indicating the inclination of target topography 70 in operator's view. Second FIG. 62 is located on a virtual straight line 62L (second straight line) parallel to target topography 70 in operator's view.

For example, second FIG. 62 is both or one of a straight line 62a and a triangular FIG. 62b. Straight line 62a is a straight line superimposed on straight line 62L. Corner 62bt of triangular FIG. 62b is located on straight line 62L.

Straight line 61L and straight line 62L are set so as to pass through the same point coordinate fixed on display 42. For example, straight line 61L and straight line 62L are set to pass through the same point (center 8TC in the width direction of the number of blade edges 8TG) in operator's view.

As illustrated in FIG. 11(E), processing unit 44 of controller 39 generates third FIG. 63 connecting first FIG. 61 and second FIG. 62 in operator's view. Third FIG. 63 continuously connects first FIG. 61 and second FIG. 62 without interruption. For example, third FIG. 63 extends in a belt shape and connects first FIG. 61 and second FIG. 62.

For example, third FIG. 63 is generated as the arc portion in the belt in arc image 60C. For example, third FIG. 63 is generated in a color different from that of other arc portions in the belt in arc image 60C.

When the actual posture of bucket 8 changes due to the excavation, the posture of bucket image 8G in support image 60 also changes according to the actual posture of bucket 8. When the inclination in the direction in which the plurality of blade edges 8TG are arranged changes due to the posture change of bucket image 8G, the position of first FIG. 61 changes according to the change in the inclination. Specifically, first FIG. 61 moves in the circumferential direction within the belt of arc image 60C. Thus, the circumferential length of third FIG. 63 having the arc shape changes.

<Method for Controlling Display System>

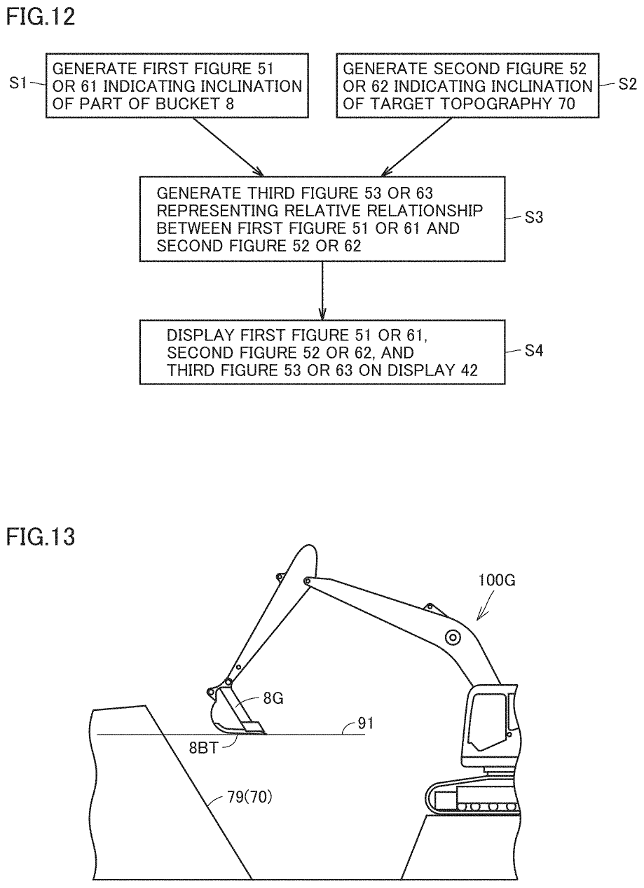

With reference to FIG. 12, a method for controlling the display system of the embodiment will be described below.

FIG. 12 is a flowchart illustrating the method for controlling the display system of the embodiment. As illustrated in FIG. 12, processing unit 44 of controller 39 generates first FIG. 51 or 61 indicating the inclination of a part of bucket 8 (step S1). Processing unit 44 of controller 39 generates first FIG. 51 as described with reference to FIG. 10(C). In addition, processing unit 44 of controller 39 generates first FIG. 61 as described with reference to FIG. 11(C).

Processing unit 44 of controller 39 generates second FIG. 52 or 62 indicating the inclination of target topography 70 (step S2). Processing unit 44 of controller 39 generates second FIG. 52 as described with reference to FIG. 10(D). In addition, processing unit 44 of controller 39 generates second FIG. 62 as described with reference to FIG. 11(D).

Processing unit 44 of controller 39 generates third FIG. 53 connecting first FIG. 51 and second FIG. 52 or third FIG. 63 connecting first FIG. 61 and second FIG. 62 (step S3). Processing unit 44 of controller 39 generates third FIG. 53 as described with reference to FIG. 10(E). In addition, processing unit 44 of controller 39 generates third FIG. 63 as described with reference to FIG. 11(E).

Processing unit 44 of controller 39 displays support image 50 including first FIG. 51, second FIG. 52, and third FIG. 53 or support image 60 including first FIG. 61, second FIG. 62, and third FIG. 63 on display 42 (step S4). As illustrated in FIG. 6 or 8, processing unit 44 of controller 39 displays support image 50 on display 42 together with bucket image 8G, image 79 of the target construction topography, and the like. Processing unit 44 of controller 39 switches between the display in FIG. 6 and the display in FIG. 8 based on the switching operation of the support screen by the operator.

As illustrated in FIG. 7, processing unit 44 of controller 39 displays support image 60 on display 42 together with bucket image 8G, image 79 of the target construction topography, and the like. Processing unit 44 of controller 39 switches the display in FIG. 6, the display in FIG. 7, and the display in FIG. 8 based on the switching operation of the support screen by the operator.

On the support screen, only third FIGS. 53, 63 may be displayed as support images 50 or 60, and first FIGS. 51, 61 and second FIGS. 52, 62 may not be displayed.

<Modifications>

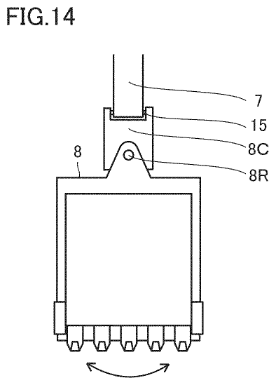

With reference to FIGS. 13 and 14, a modification of the display system of the embodiment will be described below.

FIG. 13 is a view illustrating the image in which the support image indicating an extension line of a bucket bottom surface is displayed in side view of the hydraulic excavator as the modification of the support screen displayed on the display unit. FIG. 14 is a view illustrating a tilt bucket.

As illustrated in FIG. 13, the modification of the support screen includes working machine image 100G, image 79 (second figure) of the target construction topography, and a support image 91 (first figure). Working machine image 100G is an image of the working machine in side view. Working machine image 100G includes an image 8G of the bucket (excavation tool). Image 79 of the target construction topography includes target topography 70.

Image 79 of the target construction topography indicates the inclination of the target topography. Support image 91 is a straight line extending along bottom surface 8BT of the bucket and extending from bottom surface 8BT of the bucket. A straight line constituting support image 91 preferably intersects with a straight line that is image 79 of the target construction topography and indicates the inclination of the target topography.

When the actual posture of bucket 8 changes due to the excavation, the posture of bucket image 8G on the support screen also changes according to the actual posture of bucket 8. When the inclination of bottom surface 8BT of the bucket changes due to the posture change of bucket image 8G, the position and inclination of support image 91 changes according to the change in the inclination. In this modification, support image 91 and image 79 of the target construction topography become support displays for supporting the operation of the operator.

The operator can check the inclination of bucket 8 with respect to target topography 70 in real time by visually recognizing support image 91. Thus, the inclination angle of bucket 8 can be appropriately operated at the time of excavating target topography 70.

Processing unit 44 of controller 39 displays the support screen in FIG. 13 on display 42 of display input device 38.

As illustrated in FIG. 14, tilt bucket 8 may be used as excavation tool 8 used in working machine 100. Tilt bucket 8 is attached to a coupling member 8C through a rotation shaft (tilt pin) 8R. Coupling member 8C is attached to the distal end of arm 7 through bucket pin 15. Rotation shaft 8R extends in the direction orthogonal to the extending direction of bucket pin 15. Tilt bucket 8 is swingable in an arrow direction in the drawing with respect to the operation plane of working implement 2 by rotating around rotation shaft 8R.

<Effects>

An advantageous effect of the embodiment will be described below.

According to the embodiment, as illustrated in FIGS. 6 and 8, third FIG. 53 connecting first FIG. 51 indicating the inclination of a part of bucket 8 and second FIG. 52 indicating the inclination of target topography 70 is displayed by processing unit 44 of controller 39. When the actual posture of bucket 8 changes due to the excavation, the inclination of first FIG. 51 with respect to second FIG. 52 changes, and accordingly third FIG. 53 changes. Thus, the operator can more easily and visually understand the positional relationship between target topography 70 and bucket 8. Furthermore, the operator can check the inclination of bucket 8 with respect to target topography 70 in real time by visually checking the change of third FIG. 53 on display 42. Thus, the inclination angle of bucket 8 can be appropriately operated at the time of excavating target topography 70.

According to the embodiment, as illustrated in FIG. 7, third FIG. 63 connecting first FIG. 61 indicating the inclination of a part of bucket 8 and second FIG. 62 indicating the inclination of target topography 70 is displayed by processing unit 44 of controller 39. Thus, similarly to FIGS. 6 and 8, the operator can more easily visually understand the positional relationship between the target topography 70 and the bucket 8. In addition, the inclination angle of bucket 8 can be appropriately operated during the excavation so as to achieve target topography 70.

According to the embodiment, as illustrated in FIGS. 6 and 8, processing unit 44 of controller 39 sets the figure indicating the inclination of bottom surface 8BT of bucket 8 to first FIG. 51. Thus, the inclination of bucket 8 can be easily and visually understood in side view.

According to the embodiment, as illustrated in FIG. 7, processing unit 44 of controller 39 sets the figure indicating the inclination of blade edge 8TG of bucket 8 (inclination in the direction in which the plurality of blade edges 8TG are arranged) to first FIG. 51. Thus, the inclination of bucket 8 can be easily and visually understood in operator's view.

According to the embodiment, as illustrated in FIGS. 10(D) and 11(D), processing unit 44 of controller 39 sets first straight lines 51L, 61L and second straight lines 52L, 62L so as to pass through fixed point coordinates on display 42. Thus, third FIGS. 53, 63 are displayed at the fixed positions on display 42. For this reason, third FIGS. 53, 63 are prevented from moving out of the display range by moving in display 42.

According to the embodiment, as illustrated in FIGS. 6 to 8, processing unit 44 of controller 39 displays third FIGS. 53, 63 on display 42 along a circle centered on a predetermined portion. Thus, third FIGS. 53, 63 change along the circle. For this reason, the operator can easily recognize the change in third FIGS. 53, 63.

According to the embodiment, as illustrated in FIG. 6, processing unit 44 of controller 39 displays bucket image 8G and displays, as a predetermined portion, third FIG. 53 on display 42 along the circle centered on a predetermined portion of bucket image 8G. Thus, the operator can always view the periphery of the working target of display 42 without moving the line of sight.

According to the embodiment, as illustrated in FIG. 6, processing unit 44 of controller 39 displays the circle so as to surround the periphery of bucket image 8G. Thus, the operator can always view the periphery of the working target of display 42 without moving the line of sight.

According to the embodiment, as illustrated in FIG. 8, processing unit 44 of controller 39 displays working machine image 100G and displays, as a predetermined portion, third FIG. 53 on display 42 along a circle centered on a predetermined portion of working machine image 100G. Thus, the operator easily grasps the entire work situation.

According to the embodiment, as illustrated in FIG. 8, processing unit 44 of controller 39 displays, as a predetermined portion in working machine image 100G, third FIG. 53 on display 42 along a circle centered on machine body image 1G of the working machine. Thus, the operator easily grasps the entire work situation.

According to the embodiment, as illustrated in FIG. 8, processing unit 44 of controller 39 displays a circle so as to surround machine body image 1G. Thus, the operator easily grasps the entire work situation.

According to the embodiment, as illustrated in FIGS. 6 and 8, processing unit 44 of controller 39 can select, as the center of the circle, a portion from among a plurality of options including the predetermined portion of bucket image 8G and the predetermined portion of working machine image 100G. Thus, the center of the circle can be switched between the predetermined portion of bucket image 8G and the predetermined portion of working machine image 100G. For this reason, when the predetermined portion of bucket image 8G is set to the center of the circle, the periphery of the work target of display 42 can be always viewed without moving the line of sight. When the predetermined portion of working machine image 100G is set to the center of the circle, the entire work situation can be easily grasped.

In addition, according to the embodiment, as illustrated in FIG. 13, processing unit 44 of controller 39 displays the first figure that is straight line 91 extended from bottom surface 8BT of bucket 8 in side view of bucket 8 and the second figure indicating the inclination of image 79 of the target construction topography. Thus, the operator can easily and visually understand the positional relationship between image 79 of the target construction topography and bucket 8.

It should be considered that the disclosed embodiment is illustrative and non-restrictive in every respect. The scope of the present invention is defined by not the description above, but the claims, and it is intended that all modifications within the meaning and scope equivalent to the claims are included in the present invention.

### REFERENCE SIGNS LIST

1: machine body, 1G: machine body image, 2: working implement, 2G: image of working implement, 3: revolving body, 3CW: counter weight, 3EG: machine chamber, 4: operator cab, 4S: driver's seat, 5: traveling device, 5a: crawler belt, 5c: hydraulic motor, 6: boom, 7: arm, 8: bucket, 8B: blade, 8C: coupling member, 8BT: bottom surface, 8G: bucket image, 8R: rotation axis, 8T, 8TG: blade edge, 8TC: center, 9: handrail, 10: boom cylinder, 11: arm cylinder, 12: bucket cylinder, 13: boom pin, 14: arm pin, 15: bucket pin, 16: pin, 18A, 18B, 18C: working implement posture sensor, 19: position detector, 21, 22: antenna, 24: inclination angle sensor, 25: operation device, 26: working implement electronic control device, 27: working machine control device, 31L, 31R: working implement operation member, 32L, 32R: working implement operation detector, 33L, 33R: travel control member, 34L, 34R: travel control detector, 35: working implement-side storage, 36: arithmetic unit, 37D: traveling control valve, 37SAM, 37SBK, 37SBM, 37SRM, 37S1b, 37S1f, 37Srb, 37Srf: hydraulic sensor, 37W: working control valve, 38: display input apparatus, 39: controller, 40: server, 41: input unit, 42: display, 43, 45: storage, 44: processing unit, 47: hydraulic pump, 50, 60, 91: support image, 50C: annular image, 51, 61: first figure, 51a, 52a, 61a, 62a: straight line, 51L, 61L: first straight line, 51b, 52b, 61b, 62b: figure, 51bt, 52bt, 61bt, 62bt: corner, 52, 62: second figure, 52L, 62L: second straight line, 53, 63: third figure, 60C: arc image, 70: target topography, 71: design surface, 77: plane, 79: image of target construction topography, 80: intersection line, 100, 100a: working machine (hydraulic excavator), 100G: working machine image, 100b: retrofitted kit, 101: display system, AX1: center axis, AX3: axis, L1, L2, L3: length, LA, LB1, LB2: position, Ng: vertical direction, P, P1, P2: reference position data, Q: revolving unit orientation data

1. A display system comprising:
a display; and
a controller that displays a third figure representing a relative relationship between a first figure indicating an inclination of a part of an excavation tool and a second figure indicating an inclination of a target topography on the display.

2. The display system according to claim 1, wherein the third figure is a figure connecting the first figure and the second figure.

3. The display system according to claim 1, wherein the controller sets a figure indicating an inclination of a bottom surface of a bucket to the first figure.

4. The display system according to claim 1, wherein the controller sets a figure indicating an inclination of a blade edge of a bucket to the first figure.

5. The display system according to claim 1, wherein the controller sets a first straight line along an inclination indicated by the first figure and a second straight line along an inclination indicated by the second figure so as to pass through a fixed point coordinate on the display.

6. The display system according to claim 1, wherein the controller displays the third figure on the display along a circle centered on a predetermined position.

7. The display system according to claim 6, wherein the controller displays an image of the excavation tool and displays, as the predetermined position, the third figure on the display along a circle centered on a predetermined portion in the image of the excavation tool.

8. The display system according to claim 7, wherein the controller displays the circle so as to surround a periphery of the image of the excavation tool.

9. The display system according to claim 6, wherein the controller displays an image of a working machine including the excavation tool and displays, as the predetermined position, the third figure on the display along a circle centered on a predetermined portion in the image of the working machine.

10. The display system according to claim 9, wherein the controller displays, as the predetermined portion in the image of the working machine, the third figure on the display along a circle centered on an image of a machine body of the working machine.

11. The display system according to claim 10, wherein the controller displays the circle so as to surround a periphery of the image of the machine body.

12. The display system according to claim 6, wherein the controller is capable of selecting, as the center of the circle, a portion from among a plurality of options including a predetermined portion of the image of the excavation tool and a predetermined portion of the image of the working machine.

13. A display system comprising:
a display; and
a controller that displays a first figure that is a straight line extended from a bottom surface of a bucket in side view of the bucket and a second figure that indicates an inclination of a target topography.

14. A non-transitory computer readable medium storing a program that causes a processor of a controller to execute:
generating a first figure indicating an inclination of a part of an excavation tool;
generating a second figure indicating an inclination of a target topography;
generating a third figure representing a relative relationship between the first figure and the second figure; and
displaying the third figure on a display.

15. A method for controlling a display system, the method comprising:
generating a first figure indicating an inclination of a part of an excavation tool;
generating a second figure indicating an inclination of a target topography;
generating a third figure representing a relative relationship between the first figure and the second figure; and
displaying the third figure on a display.
